(19) United States
(12) Patent Application Publication
(10) Pub. No.: US 2011/0007062 A1
(43) Pub. Date: Jan. 13, 2011

(54) DISPLAY PANEL AND DRIVING METHOD THEREOF

(75) Inventors: SHU-MING CHANG, YANGMEI TOWN (TW); MING-WEI HUANG, YANGMEI TOWN (TW); HSIANG-LUN LIU, TAOYUAN CITY (TW)

Correspondence Address: Flash Intellectual Property, Inc.;Attn. Cheng-Ju Chiang, P.O. Box 766, Chino, CA, 91708, US

(73) Assignee: CHUNGHWA PICTURE TUBES, LTD., BADE CITY (TW)

(21) Appl. No.: 12/577,720

(22) Filed: Oct. 13, 2009

(30) Foreign Application Priority Data
Jul. 8, 2009 (TW) 098123076

(51) Int. Cl. G09G 5/00; G09G 3/30; G09G 3/20; G09G 3/36

(52) U.S. Cl. 345/213; 345/76; 345/55; 345/92; 345/204; 345/87; 345/75.2; 345/60

(57) ABSTRACT

A display panel and a driving method thereof are disclosed. The display panel comprises a plurality of pixel rows, a plurality of data lines and a plurality of gate lines. Each of the pixel rows includes pairs of first and second pixels adjacent to each other. The data lines are positioned between the first and the second pixels, respectively. The gate lines include first, second, third and fourth gate lines arranged in an alternating manner. The method comprises the following steps: turning on the gate lines in a sequence of first, second, fourth and third gate lines; and transmitting the data signal to the pixels through the data lines. The panel is applicable to an LCD panel and an LCD apparatus.

### FIELD OF THE INVENTION

The present invention relates to a display panel and a driving method thereof, and more particularly, to a display panel and a driving method for reducing the number of data lines.

### BACKGROUND OF THE INVENTION

Currently, a display panel, such as a liquid crystal display (LCD) panel or an organic light emitting diode (OLED) display panel, comprises a bottom glass substrate having a plurality of pixels and a plurality of signal lines, such as scanning lines and data lines. Each of the pixels receives the control signals, such as scanning signals and pixel voltage, from the corresponding signal line, thereby displaying image.

Refer to FIG. 1A and FIG. 1B. FIG. 1A is a partial schematic diagram showing a conventional display panel, and FIG. 1B shows waveforms of signals for the conventional display panel. As shown in FIG. 1A, the display panel includes a plurality of gate lines G1-G4, a plurality of data lines D1, D2 and a plurality of pixels P1-P4. At this time, two pixels P1, P2, or P3, P4, being adjacent in the direction of the gate lines G1-G4 can be connected to a single data line D1 or D2 for reducing the number of data lines. Therefore, the number of data drivers (not shown) can be reduced for purpose of reducing the manufacturing cost. As shown in FIG. 1A and FIG. 1B, gate signals Gate1-Gate4 are transmitted to the pixels P1-P4 by the gate lines G1-G4, and data signals Data (Data1, Data2 . . . ) are transmitted to the pixels P1-P4 by the data lines D1, D2 and cooperated with a common voltage Vcom for controlling the pixels P1-P4 to display images.

However, the signals (such as the common voltage Vcom or the gate signals Gate1-Gate4) received by the pixels P1-P4 are not ideal waveforms (such as square waveforms), therefore resulting in an abnormality of the displaying images. Taking the display panel, an LCD panel in FIG. 1A, for example, at this time, as shown in FIG. 1B, the common voltage Vcom is not an ideal waveform. Therefore, when the gate lines G1 and G3 are turned on, the common voltage Vcom is still charging or discharging, resulting in an incomplete charging of the LCD cell, and the deflection of the liquid crystal molecules can not be controlled perfectly, resulting in the brightness difference of the pixels. Furthermore, the brightness difference of the pixels is susceptible to occur on the same pixel row, such as G1, G3, or G2, G4, resulting in a line defect. Namely, the unexpected bright lines or dark lines occurred on the screen may thereby affect the display quality.

### SUMMARY OF THE INVENTION

Therefore, an aspect of the present invention is to provide a display panel and a driving method thereof to reduce the number of the data lines, thereby reducing the manufacturing cost.

Another aspect of the present invention is to provide a display panel and a driving method thereof to improve line defect, thereby enhancing the display quality.

According to one embodiment of the present invention, the display panel comprises a substrate, a plurality of pixel rows, a plurality of data lines and a plurality of gate lines. The pixel rows are arranged in a direction, wherein each of the pixel rows includes pairs of first and second pixels being adjacent to each other. The data lines are disposed on the substrate and between the first and second pixels respectively. The gate lines are disposed on the substrate crossing the data lines, wherein the gate lines include first, second, third and fourth gate lines arranged in an alternating manner, and the gate lines are turned on in a sequence of first, second, fourth and third gate lines.

According to another embodiment of the present invention, the driving method is applicable for a display panel which comprises a plurality of pixel rows, a plurality of data lines and a plurality of gate lines, and each of the pixel rows includes pairs of first and second pixels being adjacent to each other, and the data lines are disposed on the substrate and between the first and second pixels, respectively, and the gate lines cross the data lines and include first, second, third and fourth gate lines arranged in an alternating manner, and the method comprises: turning on the gate lines in a sequence of first, second, fourth and third gate lines in a predetermined period; and transmitting a data signal through the data lines to the first pixels and the second pixels.

Therefore, with the use of the display panel and the driving method thereof disclosed in the embodiments of the present invention, the number of the data lines can be reduced, and the problem of the brightness difference of the pixels can be improved to enhance the display quality.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a partial schematic diagram showing a conventional display panel;

FIG. 1B shows waveforms of signals for the conventional display panel;

FIG. 2 is a schematic view showing a display panel according to one embodiment of the present invention;

FIG. 3 is a partially schematic view showing a display panel according to one embodiment of the present invention;

FIG. 4 shows waveforms of signals for a display panel according to one embodiment of the present invention;

FIG. 5 is a flow diagram showing a driving method of the display panel according to one embodiment of the present invention;

FIG. 6 is a partially schematic view showing a display panel according to another embodiment of the present invention; and

FIG. 7 shows waveforms of signals for a display panel according to another embodiment of the present invention.

### DETAILED DESCRIPTION OF THE PREFERRED EMBODIMENT

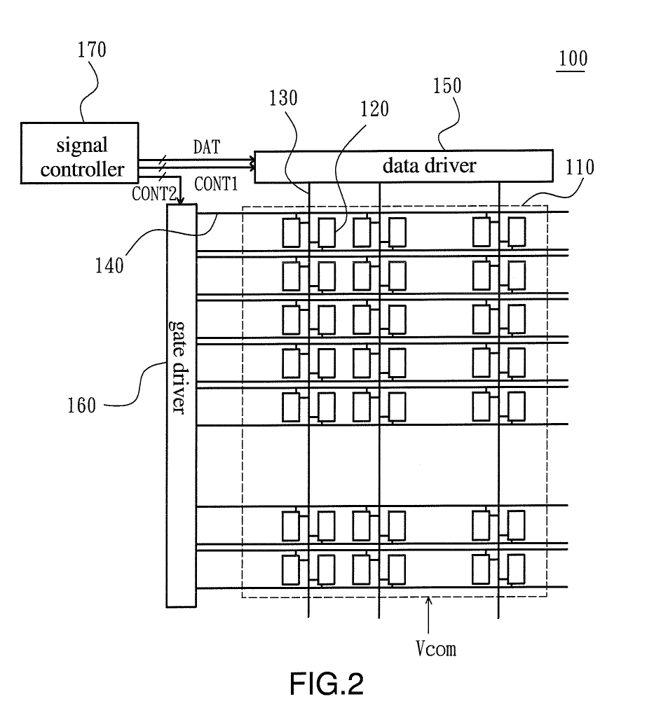

In order to make the illustration of the present invention more explicit and complete, the following description is stated with reference to FIG. 2 through FIG. 7.

Referring to FIG. 2, presented herein is a schematic view showing a display panel according to one embodiment of the present invention. The display panel 100 and the driving method thereof can be applicable to a display apparatus, such as a liquid crystal display (LCD), an organic light emitting diode (OLED) display, a plasma display panel (PDP) or a field emission display (FED). Taking the LCD for example, the display panel 100 may be an LCD panel assembled with a backlight module, thereby forming the LCD.

Referring to FIG. 2 again, the display panel 100 of the present embodiment comprises a substrate 110, a plurality of pixel rows 120, a plurality of data lines 130, a plurality of gate lines 140, a data driver 150, a gate driver 160 and a signal controller 170. The data lines 130 and the gate lines 140 are arranged in a crisscross pattern on the substrate 110. The pixels of the pixel rows 120 are arranged in a matrix manner on the substrate 110, and positioned between the data lines 130 and the gate lines 140. The data driver 150 is electrically connected to one side of the data lines 130 and includes data driving ICs (not shown) configured to drive the data lines 130. The gate driver 160 is electrically connected to one side of the gate lines 140 and includes gate driving ICs (not shown) configured to drive the gate lines 140. The signal controller 170 is electrically connected to the data driver 150 and the gate driver 160 and configured to control the data driver 150 and the gate driver 160. Therefore, the data driver 150, the gate driver 160 and the signal controller 170 can form a driving module electrically connected to the display panel 100.

Referring to FIG. 2 again, the substrate 110 may be a glass substrate or a flexible plastic substrate. In this embodiment, the substrate 110 may be a thin film transistor (TFT) array substrate. When the display panel 100 is an LCD panel, it may further comprise a liquid crystal layer (not shown) and another substrate (not shown), such as a color filter (CF) substrate. At this time, the liquid crystal layer is formed between the TFT array substrate (substrate 110) and the CF substrate. The CF substrate can include a common electrode configured to provide a common voltage Vcom.

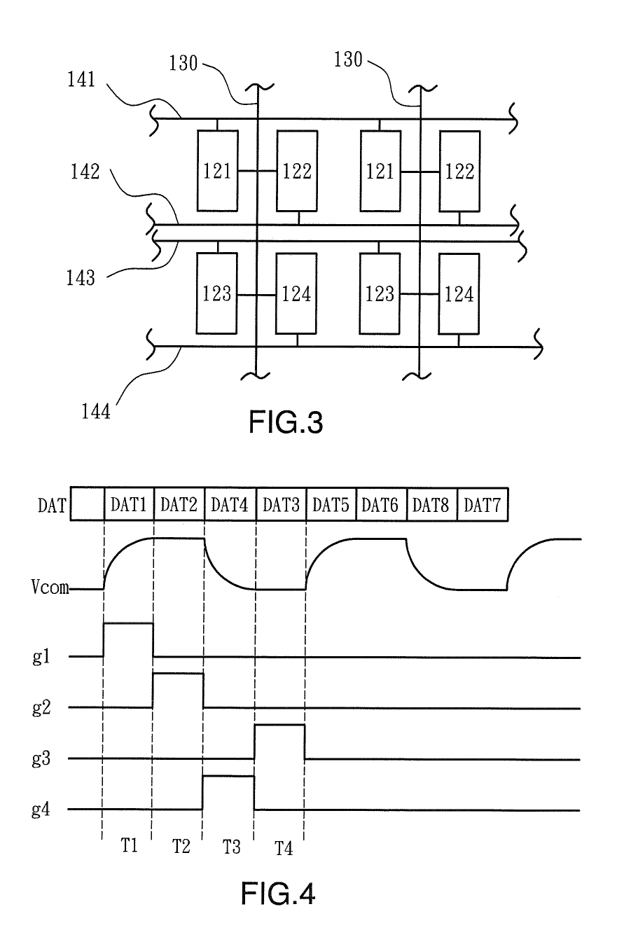

Referring to FIG. 3, presented herein is a partially schematic view showing a display panel according to one embodiment of the present invention. The pixel rows 120 are arranged in a direction along the gate lines 140 on the substrate 110. Each of the pixel rows 120 includes pairs of first pixels 121, 123 and second pixels 122, 124 being adjacent to each other. The first pixels 121, 123 and the second pixels 122, 124 are arranged in the direction along the gate lines 140 alternately. Each of the pixels 121-124 can include a pixel electrode (not shown) and switch element (not shown). The switch element may be a TFT electrically connected to the pixel electrode, the data lines 130 and the gate lines 140. When the display panel 100 is the LCD panel, the liquid crystal layer can be charged by the pixel electrodes of the pixels 121-124 and the common electrode of the CF substrate, thereby forming an electric field to control the liquid crystal molecules thereof to deflect.

Referring to FIG. 3 again, the material of the data lines 130 and the gate lines 140 may be Al, Ag, Cu, Mn, Mo, Cr, Ta, Ti, Mg, Zr or alloys thereof. The data lines 130 are connected between the first pixels 121, 123 and the second pixels 122, 124, and the first and second pixels adjacent to each other 121, 122 or 123, 124 in each pair are connected to the same data line 130, i.e. each of the data lines 130 is connected to the first and second pixels 121, 122 or 123, 124 positioned at both sides thereof. Therefore, the number of the data lines 130 of the display panel 100 can be reduced for reducing the number of the data driving IC, thereby reducing the manufacturing cost.

Referring to FIG. 3 again, the gate lines 140 are disposed between the pixel rows 120 and crossing the data lines 130. The gate lines 140 include first, second, third and fourth gate lines 141, 142, 143 and 144 being arranged in an alternating manner, wherein each two of the gate lines 140 are disposed at both sides of each of the pixel rows 120 (such as pixels 121, 122 or 123, 124), respectively. Therefore, the first gate line 141 and the second gate line 142 are respectively disposed at both sides of a pixel row 120 (such as pixels 121, 122), and the third gate line 143 and the fourth gate line 144 are respectively disposed at both sides of the next pixel row 120 (such as pixels 123, 124). At this time, in a pixel row 120 corresponding to the same data line 130, the first pixels 121 are connected to the first gate line 141, and the second pixels 122 are connected to the second gate line 142. In the next pixel row 120 corresponding to the same data line 130, the first pixels 123 are connected to the third gate line 143, and the second pixels 124 are connected to the fourth gate line 144.

Referring to FIG. 2 again, the signal controller 170 of the present embodiment can provide a data control signal CONT1 and a processed image data signal DAT to the data driver 150, and provide a gate control signal CONT2 to the gate driver 160. The data control signal CONT1 may include a horizontal synchronization start signal, a lording signal, a data clock signal and an inversion signal. The gate control signal CONT2 may include a gate clock signal, scanning start signals and an output enable signal.

Referring to FIG. 2 and FIG. 4. FIG. 4 shows waveforms of signals for a display panel according to one embodiment of the present invention. The data driver 150 can transmit the image data signal DAT to the data lines 130 according to the data control signal CONT1 provided by the signal controller 170, wherein the image data signal DAT provided by the data driver 150 can be applied to the data lines 130 in the form of a data voltage. The gate driver 160 can transmit the gate signals g1-g4 to the gate lines 140 according to the gate control signal CONT2 provided by the signal controller 170, wherein the gate signals g1-g4 provided by the gate driver 160 can be applied to the gate lines 140 in the form of a gate-on voltage for turning on the gate lines 140. At this time, the gate signals g1-g4 provided by the gate driver 160 can be applied to the switch elements of the pixels 121-124 connected to the gate lines 140 so as to provide the image data signal DAT transmitted by the data lines 130 to the pixels 121-124 through the switch elements. The gate lines 140 are turned on in a sequence of first, second, fourth and third gate lines 141-142-144-143, i.e. the gate-on voltage is applied by the gate lines 140 in a sequence of first, second, fourth and third gate lines 141-142-144-143.

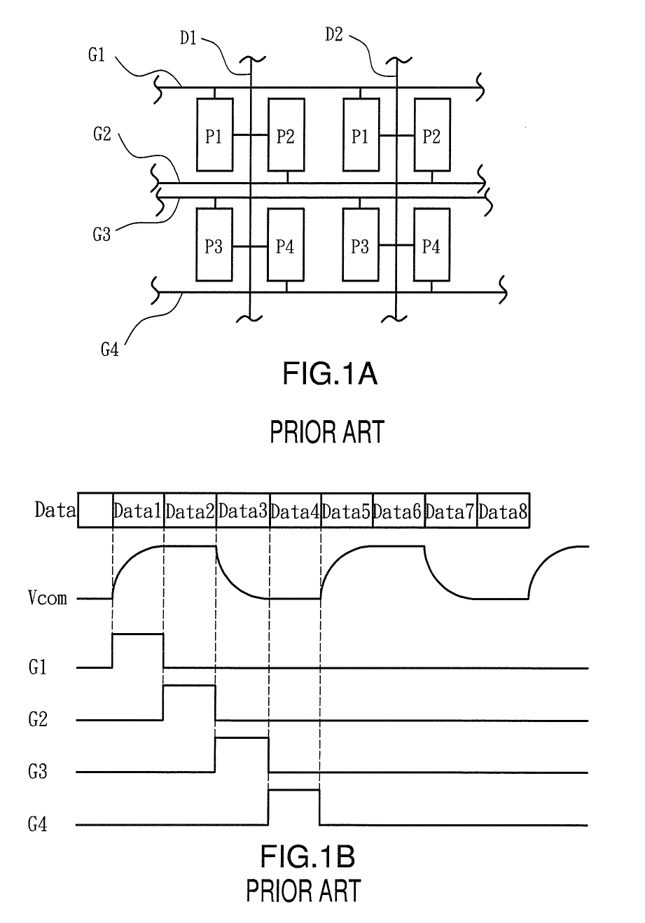

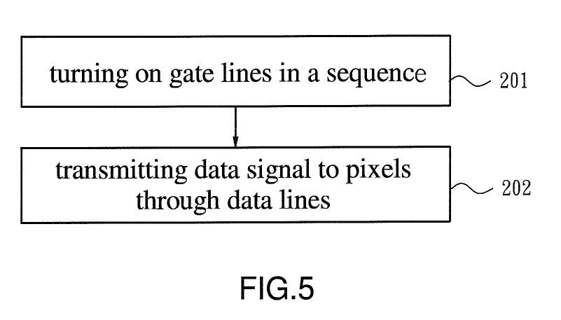

Referring to FIG. 3, FIG. 4 and FIG. 5. FIG. 5 is a flow diagram showing a driving method for the display panel according to one embodiment of the present invention. As shown in FIG. 4, g₁, g₂, g₃, g₄ respectively represent the gate signals of the first gate line 141, the second gate line 142, the third gate line 143 and the fourth gate line 144, and DAT (DAT1, DAT2 . . . ) represents the data signal DAT transmitted to the data lines 130, and Vcom represents the common voltage which may be an alternating current (AC) voltage applied to the display panel 100 with an approximate square waveform in a predetermined period. When executing the driving method of the display panel according to the present embodiment, firstly, the gate lines 140 are turned on by the gate driver 160 in a sequence of first, second, fourth and third gate lines in the predetermined period according to the gate control signal CONT2 which is provided by the signal controller 170 (step 201), i.e. the gate-on voltage is applied by the gate lines 140 in a sequence of first, second, fourth and third gate lines 141-142-144-143. In the present embodiment, in one-half of the predetermined period corresponding to the common voltage Vcom, two gate lines can be turned on, such as the first gate line 141 and the second gate line 142. Next, the data signal DAT is transmitted to pixels 121-124 by the data driver 150 through the data lines 130 according to the data control signal CONT1 which is provided by the signal controller 170 (step 202), i.e. the data voltage is applied to the pixels 121-124 by the data driver 150 through the data lines 130. At this time, when the gate lines 140 are turned on, the data voltage can be applied to the pixel electrodes by the switch elements of the pixels 121-124, thereby charging the pixels 121-124. Therefore, the gate lines 140 are turned on in a sequence of 141-142-144-143, and the pixels are charged in a sequence of 121-122-124-123 corresponding to time intervals T₁-T₂-T₃-T₄. As shown in FIG. 1B, since the common voltage Vcom is not a perfect square waveform, an incomplete charging or discharging is susceptible to occur at the time intervals T₁ and T₃, thus resulting in a brightness difference of the pixels 121-124. In the present embodiment, the time intervals T₁ and T₃ respectively correspond to the pixels 121 and 124, and the pixels 121 and 124 are respectively positioned at different pixel columns (in a direction of the data lines 130), thereby preventing the brightness difference from occurring at the same pixel column. Therefore, the brightness difference effect can be mitigated to improve display quality.

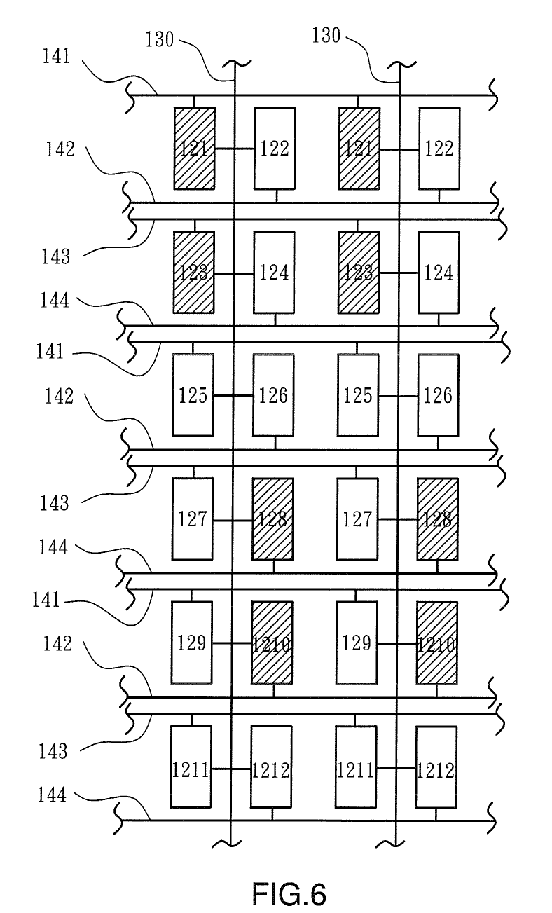

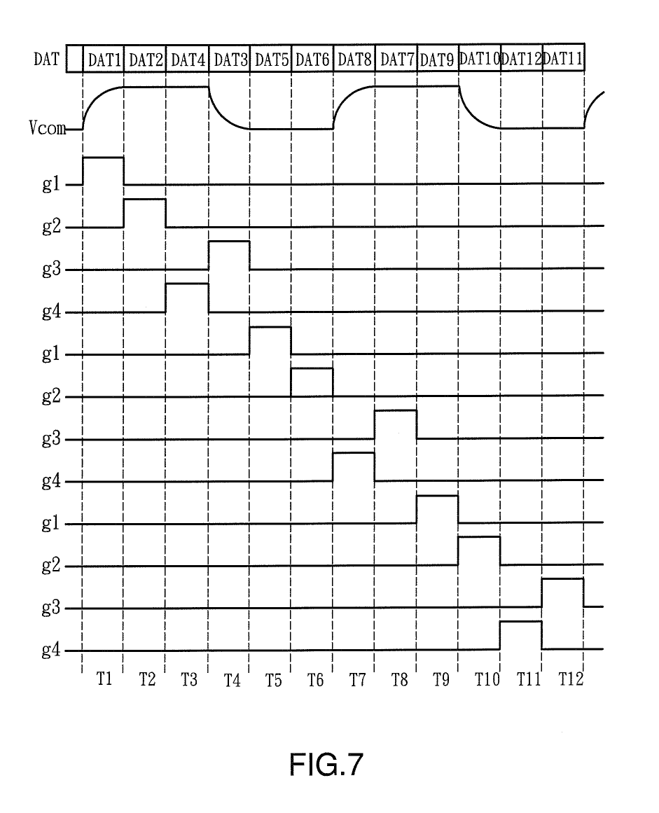

Referring to FIG. 6 and FIG. 7. FIG. 6 is a partial schematic view showing a display panel according to another embodiment of the present invention. FIG. 7 shows waveforms of signals for a display panel according to another embodiment of the present invention. In another embodiment, in one-half of the predetermined period corresponding to the common voltage Vcom, three gate lines can be turned on, such as the first gate line 141, the second gate line 142 and the fourth gate line 144. At this time, in time intervals T₁-T₁₂ (corresponding to two predetermined periods of the common voltage Vcom), the incomplete charging or discharging is susceptible to occur at the time intervals T₁, T₄, T₇, and T₁₀. Therefore, the charging or discharging of the liquid crystal cell is incomplete, resulting in the brightness difference of the pixels 121-1212. In the present embodiment, the time intervals T₁, T₄, T₇, and T₁₀ respectively correspond to the pixels 121, 123, 128, 1210, and the pixels 121, 123 and 128, 1210 with the incomplete charging or discharging are respectively positioned at different pixel columns (in a direction of the data lines 130), as shown in FIG. 6, thereby preventing the brightness difference from occurring at the same pixel column. Accordingly, the brightness difference effect can be mitigated to improve display quality.

Therefore, the display panel of the present invention and the driving method thereof can reduce the number of the data lines and improve the line defect to enhance the display quality.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A display panel, comprising:
a substrate;
a plurality of pixel rows arranged in a direction, wherein each of the pixel rows includes pairs of first and second pixels adjacent to each other;
a plurality of data lines disposed on the substrate and between the first and second pixels respectively; and
a plurality of gate lines disposed on the substrate crossing the data lines, wherein the gate lines include first, second, third and fourth gate lines arranged in an alternating manner, and the gate lines are turned on in a sequence of first, second, fourth and third gate lines.

2. The display panel as claimed in claim 1, wherein the display panel is a liquid crystal display (LCD) panel, an organic light emitting diode (OLED) display panel, a plasma display panel (PDP) or a field emission display (FED) panel.

3. The display panel as claimed in claim 1, wherein the substrate is a thin film transistor (TFT) array substrate.

4. The display panel as claimed in claim 1, further comprising:
a data driver electrically connected to one side of the data lines and configured to drive the data lines; and
a gate driver electrically connected to one side of the gate lines and configured to drive the gate lines.

5. The display panel as claimed in claim 4, further comprising:
a signal controller electrically connected to the data driver and the gate driver and configured to control the data driver and the gate driver.

6. The display panel as claimed in claim 1, wherein in each of the data lines, one of the first pixels is connected to the first gate lines, and one of the second pixels is connected to the second gate lines, and another one of the first pixels is connected to the third gate lines, and another one of the second pixels is connected to the fourth gate lines.

7. A driving method for a display panel, wherein the display panel comprises a plurality of pixel rows, a plurality of data lines and a plurality of gate lines, and each of the pixel rows includes pairs of first and second pixels adjacent to each other, and the data lines are disposed on the substrate and between the first and second pixels respectively, and the gate lines cross the data lines and include first, second, third and fourth gate lines arranged in an alternating manner, and the method comprises:
turning on the gate lines in a sequence of first, second, fourth and third gate lines in a predetermined period; and
transmitting a data signal through the data lines to the first pixels and the second pixels.

8. The method as claimed in claim 7, wherein a gate driver is utilized to provide a gate signal to the gate lines for turning on the gate lines sequentially.

9. The method as claimed in claim 8, wherein the gate driver transmits the gate signal to the gate lines according to a gate control signal provided by a signal controller.

10. The method as claimed in claim 7, wherein a data driver is utilized to provide the data signal, and the data driver transmits the data signal to the data lines according to a data control signal provided by a signal controller.

11. The method as claimed in claim 7, wherein a common voltage is applied to the display panel in the predetermined period, and two gate lines are turned on in one-half of the predetermined period.

12. The method as claimed in claim 7, wherein a common voltage is applied to the display panel in the predetermined period, and three gate lines are turned on in one-half of the predetermined period.

13. A display apparatus, comprising:
a driving module; and
a display panel electrically connected to the driving module, wherein the display panel comprises:
a substrate;
a plurality of pixel rows arranged in a direction, wherein each of the pixel rows includes pairs of first and second pixels adjacent to each other;
a plurality of data lines disposed on the substrate and between the first and second pixels respectively; and
a plurality of gate lines disposed on the substrate crossing the data lines, wherein the gate lines include first, second, third and fourth gate lines arranged in an alternating manner, and the gate lines are turned on in a sequence of first, second, fourth and third gate lines.

14. The display apparatus as claimed in claim 13, wherein the driving module comprises a data driver and a gate driver, and the data driver transmits a data signal to the data lines, and the gate driver transmits a gate signal to the gate lines.
